(19) United States
(12) Patent Application Publication
(10) Pub. No.: US 2012/0162443 A1
(43) Pub. Date: Jun. 28, 2012

(54) CONTEXTUAL HELP BASED ON FACIAL RECOGNITION

(75) Inventor: Corville O. Allen, Morrisville, NC (US)

(73) Assignee: INTERNATIONAL BUSINESS MACHINES CORPORATION, Armonk, NY (US)

(21) Appl. No.: 12/976,900

(22) Filed: Dec. 22, 2010

(51) Int. Cl. H04N 5/225

(52) U.S. Cl. 348/207.1; 348/E05.048

(57) ABSTRACT

A computer program product includes a computer readable storage medium to store a computer readable program, wherein the computer readable program, when executed on a computer, causes the computer to perform operations for providing contextual help based on a user facial expression. The operations include: capturing a user facial expression using a camera device connected to a computing device; categorizing the user facial expression into a facial expression category; collecting an application context from the computing device in conjunction with an application, wherein the application context includes a recently performed task and a current application state, wherein the current application state comprises information on a current performance of an application in which the user is operating; determining a set of available tasks relating to the application context; and automatically executing one of the set of available tasks based on the facial expression category and the application context.

### BACKGROUND

Help systems may be implemented in computing devices to create a friendlier user environment and allow users to more easily find help for using various applications within the user environment. Particularly, computing devices with increasingly improved technology, such as touch screens or multi-touch surfaces, may also have increasingly complex user interfaces or capabilities. Because of the increased complexity, users may have difficulties using the computing devices. Help systems are generally configured to include information that may aid a user in performing certain tasks within a given application or environment. Help systems may also be configured to perform certain tasks to aid a user.

Ideally, a help system would be able to provide help directly corresponding to the user's needs. Many conventional systems are able to provide general help corresponding to a specific application, but may be unable to provide specific help for the context within the application. Help or aid given by conventional help systems may be random or may not be given specifically when needed, such that the help systems may not be as useful as a user may need in a particular situation.

### SUMMARY

Embodiments of a system are described. In one embodiment, the system is a contextual help system. The system includes: a camera device connected to a computing device to capture a facial expression of a user; a facial recognition analyzer to categorize the facial expression into a facial expression category; a context analyzer to collect an application context from the computing device, wherein the application context includes a recently performed task and a current application state, wherein the current application state comprises information on a current performance of an application in which the user is operating; and a help interface to determine a set of available tasks relating to the application context and automatically execute one of the set of available tasks based on the facial expression category and the application context. Other embodiments of the system are also described. Embodiments of a computer program product and method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a contextual help system.

FIG. 2 depicts a schematic diagram of one embodiment of the contextual help system of FIG. 1.

FIG. 3 depicts a schematic diagram of one embodiment of a task mapping structure.

FIG. 4 depicts a flow chart diagram of one embodiment of a method for providing contextual help based on a user facial expression.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for a contextual help system for providing contextual help for a computing device. More specifically, the contextual help system uses an application context in conjunction with a user facial expression to determine a help task to perform, and the help system automatically executes the determined help task. In some instances, users may know how to perform basic functionalities of an application, but on more advanced screens, the help system may assist in providing help with a context based on the user's facial expression. Using the application context in conjunction with a user facial expression may allow the help system to provide more specific aid to the user instead of merely providing generalized help.

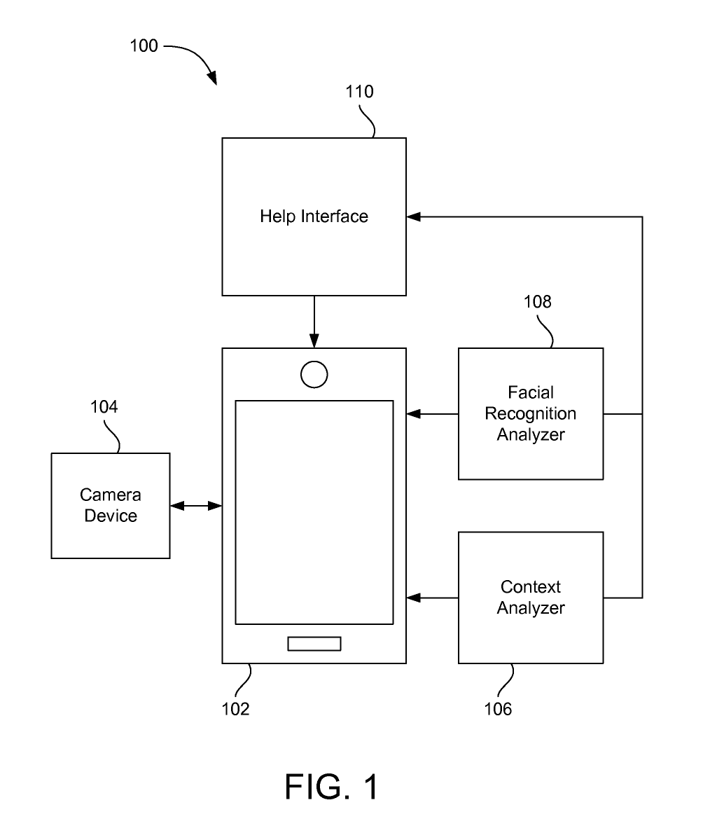

FIG. 1 depicts a schematic diagram of one embodiment of a contextual help system 100. The illustrated contextual help system 100 includes a computing device 102, a camera device 104, a context analyzer 106, a facial recognition analyzer 108, and a help interface 110. Although the help system 100 is shown and described with certain components and functionality, other embodiments of the help system 100 may include fewer or more components to implement less or more functionality.

The help system 100 provides users with aid in performing tasks or help in determining how to perform tasks based on an application context of the computing device 102 and a facial expression of the user. Linking the facial expression to the correct context-based on-screen help may allow the help system 100 to assist the user in navigating and using the features and functionality of the device within a specific application. The application context may include the context within a stand-alone application, single or multiple applications, a desktop for an operating system, or any other potential context within which the user may operate on a computing device 102. Implementing the help system 100 using the user's facial expressions may allow the help system 100 to determine what emotion the user is feeling so as to conveniently provide the user with aid at the right time and location on the device.

The computing device 102 may be any digital device that allows a user to interact with the device to perform tasks on the device 102. Examples of computing devices 102 include desktop computers, laptop computers, mobile phones and other mobile devices, and any other computing device 102 capable of implementing the help system 100 described herein.

The computing device 102 includes or is connected to a camera device 104. The camera device 104 captures a photograph of the user and transmits the photograph to a facial recognition analyzer 108 in the computing device 102. The facial recognition analyzer 108 analyzes the facial expression of the user and categorizes the facial expression into one of several facial expression categories. A context analyzer 106 determines a current application context for the computing device 102.

A help interface 110 uses the application context and facial expression category to determine a task to perform on the device to aid the user. In some embodiments, the task may include merely opening a specific help dialog showing how the user may perform a subsequent task based on the context and facial expression. In other embodiments, the help dialog displays to the user the task automatically performed by the help system 100, allowing the user to either undo the automatically executed task or view the steps for performing the task in the future. The help interface 110 may also allow the user to select options or preferences based on the automatically executed task that indicate to the help system 100 how to handle future combinations of the specified application context and facial expression. Other embodiments may allow the user to adjust other preferences that determine how the help system 100 interacts with the computing device 102.

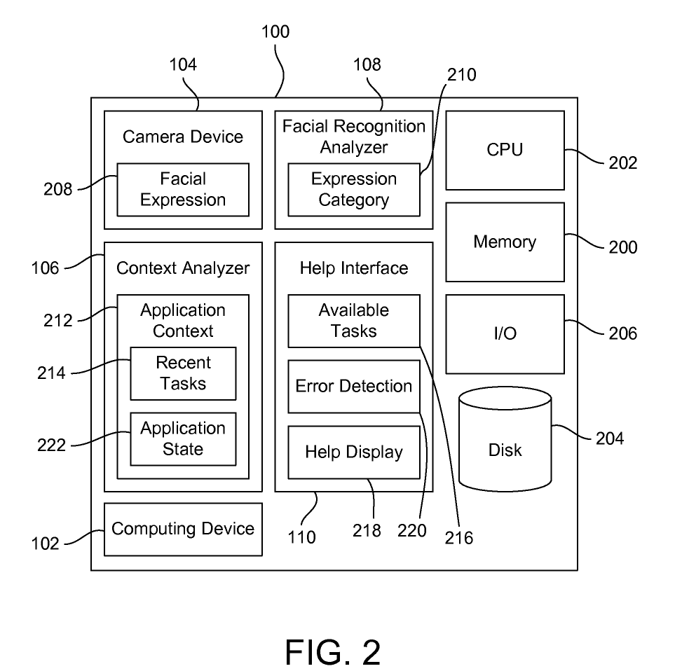

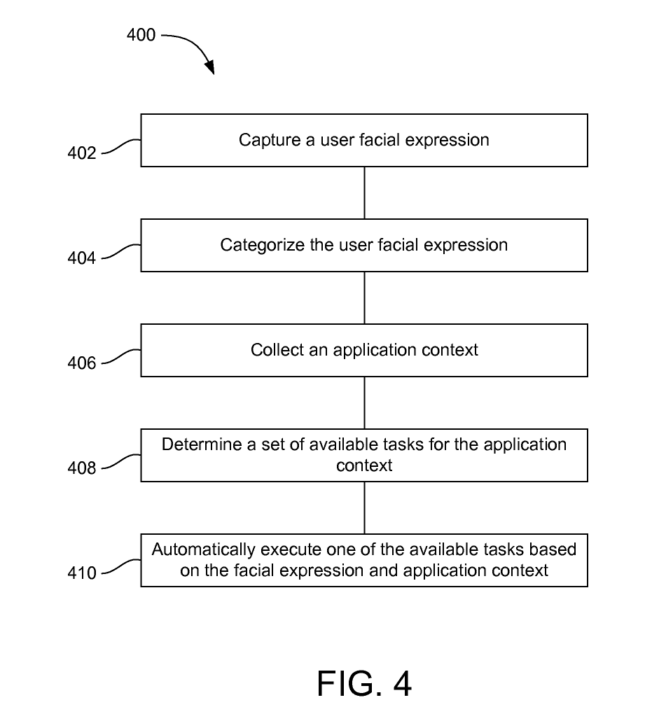

FIG. 2 depicts a schematic diagram of one embodiment of the contextual help system 100 of FIG. 1. The depicted contextual help system 100 includes various components, described in more detail below, that are capable of performing the functions and operations described herein. In one embodiment, at least some of the components of the contextual help system 100 are implemented in a computer system. For example, the functionality of one or more components of the contextual help system 100 may be implemented by computer program instructions stored on a computer memory device 200 and executed by a processing device 202 such as a CPU. The contextual help system 100 may include other components, such as a disk storage drive 204, input/output devices 206, a camera device 104, a facial recognition analyzer 108, a context analyzer 106, and a help interface 110. Some or all of the components of the contextual help system 100 may be stored on a single computing device 102 or on a network of computing devices 102. The contextual help system 100 may include more or fewer components than those depicted herein. In some embodiments, the contextual help system 100 may be used to implement the methods described herein as depicted in FIG. 4.

The contextual help system 100 includes a camera device 104. The camera device 104 is a device capable of capturing images and/or video either integrated into the computing device 102 or otherwise connected, such that any images the camera device 104 captures are transmitted to the computing device 102 for processing. The image or images captured by the camera device 104 include a user facial expression 208.

In one embodiment, the camera device 104 is a forward facing camera, such that the camera faces the user while the user is operating the device. In some embodiments, the camera device 104 may be operating continually. In such embodiments, the camera device 104 may be connected to an independent power supply to provide sufficient power to the camera device 104 without affecting power performance of the computing device 102. In other embodiments where computing devices 102 have a finite power supply, such as in mobile phones, camera devices 104 may use a significant amount of battery power. Because of the power consumption, the camera device 104 may be configured to operate intermittently or only when prompted either by the user or the help system 100. In one embodiment, the camera device 104 includes a separate graphics processing device that provides image processing capabilities separate from the CPU 202 or other processor on the computing device 102. A separate image processor may improve performance speeds and power consumption of the computing device 102 as a whole.

The help system 100 includes a facial recognition analyzer 108. In one embodiment, the facial recognition analyzer 108 includes facial recognition software that is able to digitally interpret images taken by the camera device 104 and identify a face in the images. After identifying a user's face in a captured image, the facial recognition analyzer 108 determines the user's facial expression 208 and categorizes the expression 208 into a facial expression category 210. The help system 100 may include any number of facial expression categories 210, such as angry, confused, happy, and others. The types of categories 210 may be predefined by the facial recognition software, or may be at least partially user-defined. Facial recognition software may be stored on the disk storage drive 204, and any analyzing instructions may be executed on the processor 202. In some embodiments, the facial expression category 210 for the user facial expression 208 is stored in the memory device 200 until the help system 100 completes a help process.

The help system 100 also includes a context analyzer 106. The context analyzer 106 determines a current application context 212. The current application context 212 may describe a present state 222 of an application in which the user is operating, or if the user is operating, including a stand-alone application, a temporary application, a desktop environment, a continuously running application, or any application or operating environment in which a user may operate. The application state 222 includes information on how the application in which the user is operating is currently performing. The application state 222 may include the current mode in which the application is running, the in-memory state of objects, or any data or objects that may be loaded from a disk storage 204 or database. The application state 222 may include information on objects being displayed to the user, the general function currently being provided, and the logical series of additional or related functionality to the current function. In one embodiment, the application state 222 includes any tasks that the application is currently performing. The current tasks may or may not be related to the recently performed task 214. In one embodiment, the application context 212 includes a recently executed operation or task within a given application. In other embodiments, the application context 212 includes several recently executed operations or tasks to further clarify the context 212 and to help determine what the user was attempting to achieve.

The help system 100 also includes a help interface 110. The help interface 110 may use the application context 212 to determine which help actions are available to assist the user in a set of available tasks 216. The help interface 110 uses the information retrieved and processed by the facial recognition analyzer 108 and context analyzer 106 to determine one or more specific actions to perform to assist the user. In one embodiment, the help interface 110 includes a help display 218 that is displayed on the computing device 102. The help display 218 may display a database that includes help topics pertaining to the context 212 and facial expression category 210. The database may be searchable, such that the user may either refine or otherwise alter the help topic presently displayed.

In one embodiment, the help interface 110 predicts an intended user action based on the context 212 and expression category 210 and performs the predicted action. For example, if the user performed a recent task in an application, and the camera device 104 captures an image in which the user has a facial expression 208 that is categorized by the facial recognition analyzer 108 as angry, the help interface 110 may determine that the user did not intend to do the recent task and automatically undoes the most recently performed task 214. The combination of the context 212 and facial expression category 210 may provide the help system 100 with error detection 220 to determine that an error occurred in the recently performed task 214 (user or device error), and provide on-screen help for the user to correct the error. In some embodiments, the help interface 110 automatically provides step-by-step actions for performing a predicted task. In other embodiments, the help interface 110 automatically performs the predicted task without any additional input from the user.

In embodiments where the help interface 110 automatically performs the predicted task, the help interface 110 may display a notification on the help display 218 indicating to the user that the predicted task has been performed. The notification may also include options that the user may select to accept the predicted task, to automatically perform the predicted task after the user performs the recently performed task 214 on future occasions, to undo the task, or other options. In some embodiments, the help interface 110 may display a notification to the user that the help system 100 would like to perform the predicted task and give the user the option to either perform the predicted task or reject the predicted task.

In one embodiment, the facial recognition analyzer 108 categorizes the user's facial expression 208 as a happy expression. If the context 212 is compatible, the help system 100 may automatically create a shortcut for the user to more easily perform the recently performed task 214 in the future.

The context analyzer 106 may acquire several application contexts 212, which may correspond to several recently performed tasks 214. This may allow the help system 100 to determine a context 212 corresponding to actions performed over more than one application. Consequently, the camera device 104 may capture more than one image, for example capturing one image of the user's facial expression 208 for each task performed for each application context 212. The facial recognition analyzer 108 may categorize each facial expression 208 and the help interface 110 may use the combination of multiple application contexts 212 with multiple facial expression categories 210 to determine which help task to perform.

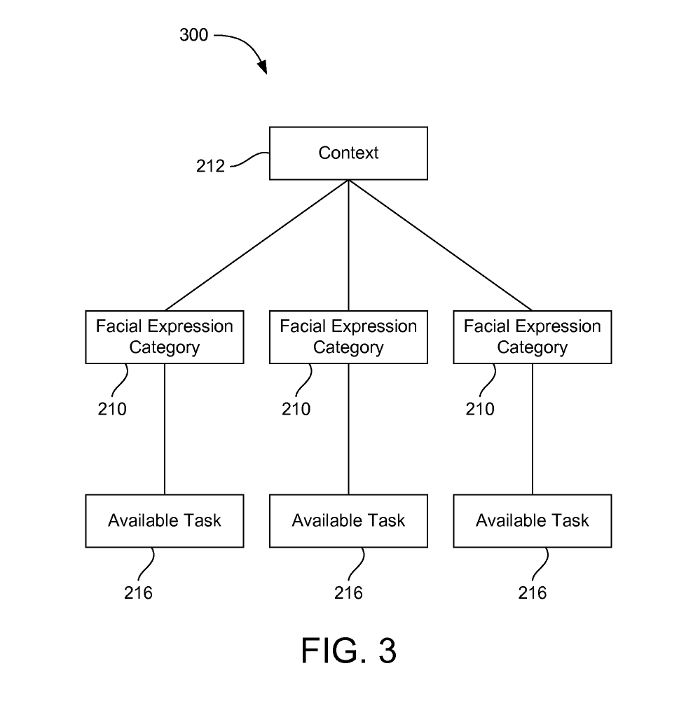

FIG. 3 depicts a schematic diagram of one embodiment of a task mapping structure 300. The task mapping structure 300 may be any data structure capable of storing the information contained in the mapping structure 300 so as to accurately map available tasks 216 within a context 212 to facial expression categories 210. In one embodiment, the task mapping structure 300 includes a simple tree structure having each application context 212 at a root level of the mapping structure 300. The mapping structure 300 may include some or all of the possible application contexts 212 in which the help system 100 may aid the user.

For each context 212, the mapping structure 300 may include each facial expression category 210 supported or created by the facial recognition analyzer 108. For example, the facial expression category 210 may be set up to categorize facial expressions 208 in a predetermined set of categories 210, such as happy, angry, confused, neutral, or others. In this embodiment, each of the facial expression categories 210 is a node in the mapping structure 300 under the context 212 root node. For each facial expression category 210, the mapping structure 300 may include one or more available tasks 216 that may be performed by the help system 100 for the corresponding context 212. In some embodiments, the available tasks 216 differ from one facial expression category 210 to another, such that each facial expression category 210 may be mapped to a different available task 216. In other embodiments, more than one facial expression category 210 may be mapped to the same available task 216, or the facial expression categories 210 may be mapped to more than one available task 216.

The available tasks 216 in the mapping structure 300 may be tasks that occur within the specific context 212 or the tasks may be general tasks that are performed on the device, such as in the operating system. The available tasks 216 may also include tasks over various applications. The available tasks 216 may also include a series of tasks to be performed in response to a particular application context 212 and user facial expression 208, such that when the user is operating in the particular application context 212 and the camera device 104 captures the specified user facial expression 208, several tasks may be performed—whether simultaneously or sequentially or some combination thereof.

The mapping structure 300 may be stored in a profile for the user or the computing device 102. The profile may be stored on the disk storage device 204 on the computing device 102 or at a remote location accessible to the computing device 102. The profile may be accessible to the user to change preferences corresponding to functionality of the help system 100 or to modify the mappings between contexts 212, facial expression categories 210, and/or available help tasks 216.

FIG. 4 depicts a flow chart diagram of one embodiment of a method 400 for providing contextual help based on a user facial expression 208. Although the method 400 is described in conjunction with the contextual help system 100 of FIG. 1, embodiments of the method 400 may be implemented with other types of contextual help systems 100.

The contextual help system 100 first captures 402 a user facial expression 208 in a digital image. In one embodiment, the help system 100 includes a forward-facing camera device 104 connected to a computing device 102, such that as the user operates the computing device 102 the camera device 104 faces the user. The help system 100 may include any camera device 104 capable of capturing digital images of the user's facial expressions 208 and transmitting the images to be processed and analyzed by facial recognition software or other facial expression categorization system.

After capturing 402 the user facial expression 208, the help system 100 categorizes 404 the user facial expression 208 into a facial expression category 210. Facial recognition software may be used to digitally interpret the image to identify the user's face in the image and to extract facial expression 208 information from the image and categorize the expression 208. The category 210 may be one of several pre-defined categories 210 that the help system 100 may be configured to recognize. In some embodiments, if the facial expression 208 does not fit into one of the predefined categories 210, the help system 100 may ignore the facial expression 208.

The help system 100 also collects 406 an application context 212. In one embodiment, the application context 212 is collected from the computing device 102. An application in which the user is currently operating may also provide information regarding the application context 212 to the help system 100. In one embodiment, the application context 212 includes a recently performed task 214 by the user that corresponds to the current application context 212. The recently performed task 214 may be the most recently executed action on the computing device 102. The application context 212 may also include an application state 222 that includes various aspects of how an application is currently performing.

The help system 100 determines 408 a set of available tasks 216 that may be performed for the present application context 212. The set of available tasks 216 may include any tasks that the user, operating system, help system 100, or otherwise may perform on the computing device 102 or in the operating environment. Examples of tasks that may be performed include saving a file, loading a file, undoing the recently performed task 214, creating a shortcut for the recently performed task 214, closing a program or application, and others not described herein. The available tasks 216 may alternatively include tasks that the user frequently performs. Including frequently performed tasks may help the help system 100 to more accurately predict which available task 216 would be most helpful to the user.

In one embodiment of the help system 100, the system determines 408 the available tasks 216 based on an input location of the recently performed task 214 on a display device of the computing device 102. For example, if the user selects an option located at one position on the display device, the available tasks 216 may be determined by identifying any option within a certain distance on the display device of the selected option. Consequently, when the user selects an option, but meant to select another option, the list of available tasks 216 may include the option that the user meant to select.

Using the facial expression category 210 and application context 212, the system then automatically executes 410 one of the available tasks 216. The help system 100 may access a mapping structure 300 having the available tasks 216 mapped to facial expression categories 210 in the current application context 212. The help system 100 may be able to determine which available task 216 or tasks to perform by accessing the mapping and executing the tasks associated with the determined facial expression category 210.

In one embodiment, the help system 100 uses several application contexts 212 and facial expression categories 210 to determine which available task 216 to execute. For example, if the mapping structure 300 indicates that a single available task 216 is mapped or tied to multiple facial expression categories 210 and contexts 212, the help system 100 may not execute the available task 216 unless all expression categories 210 and contexts 212 correlating to the available task 216 are captured or collected by the help system 100. Returning to the example of the user selecting an option, but intending to select a different option, the help system 100 may automatically undo the selected option in response to a confused or angry user facial expression 208, and may also then automatically select the nearest option to the option selected by the user.

An embodiment of a contextual help system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to provide contextual help based on a user facial expression. A contextual help system captures a user facial expression using a camera device connected to a computing device. The facial expression is categorized into a facial expression category and the help system collects an application context from the computing device. The application context includes a recently performed task. The help system determines a set of available tasks relating to the application context and automatically executes one of the set of available tasks based on the facial expression category and the application context.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. A computer readable storage medium is a specific type of computer-readable or—usable medium. Examples of a computer-readable storage medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for providing contextual help based on a user facial expression, the operations comprising:
capturing the user facial expression using a camera device connected to a computing device;
categorizing the user facial expression into a facial expression category;
collecting an application context from the computing device, wherein the application context comprises a recently performed task and a current application state, wherein the current application state comprises information on a current performance of an application in which the user is operating;
determining a set of available tasks relating to the application context; and
automatically executing one of the set of available tasks based on the facial expression category and the application context.

2. The computer program product of claim 1, wherein the set of available tasks comprises creating a shortcut for the recently performed task.

3. The computer program product of claim 1, wherein the computer program product, when executed on the computer, causes the computer to perform additional operations, comprising:
capturing a plurality of facial expressions;
collecting a plurality of application contexts for at least one application; and
automatically executing one of the set of available tasks based on a combination of the plurality of facial expressions and the plurality of application contexts.

4. The computer program product of claim 1, wherein the computer program product, when executed on the computer, causes the computer to perform additional operations, comprising:
detecting an error in the recently performed task, wherein automatically executing one of the set of available tasks comprises presenting a help display to a user.

5. The computer program product of claim 1, wherein automatically executing one of the set of available tasks is further based on an input location of the recently performed task, wherein the set of available tasks comprises a task with an input location proximate the input location of the recently performed task.

6. The computer program product of claim 1, wherein automatically executing one of the set of available tasks comprises undoing the recently performed task.

7. The computer program product of claim 1, wherein automatically executing one of the set of available tasks comprises determining a subsequent logical task, wherein the set of available tasks comprises high frequency tasks.

8. A method for providing contextual help based on a user facial expression, the method comprising:
capturing the user facial expression using a camera device connected to a computing device;
categorizing the user facial expression into a facial expression category;
collecting an application context from the computing device, wherein the application context comprises a recently performed task and a current application state, wherein the current application state comprises information on a current performance of an application in which the user is operating;
determining a set of available tasks relating to the application context; and
automatically executing one of the set of available tasks based on the facial expression category and the application context.

9. The method of claim 8, wherein the set of available tasks comprises creating a shortcut for the recently performed task.

10. The method of claim 8, further comprising:
capturing a plurality of facial expressions;
collecting a plurality of application contexts for at least one application; and
automatically executing one of the set of available tasks based on a combination of the plurality of facial expressions and the plurality of application contexts.

11. The method of claim 8, further comprising:
detecting an error in the recently performed task, wherein automatically executing one of the set of available tasks comprises presenting a help display to a user.

12. The method of claim 8, wherein automatically executing one of the set of available tasks is further based on an input location of the recently performed task, wherein the set of available tasks comprises a task with an input location proximate the input location of the recently performed task.

13. The method of claim 8, wherein automatically executing one of the set of available tasks comprises undoing the recently performed task.

14. The method of claim 8, wherein automatically executing one of the set of available tasks comprises determining a subsequent logical task, wherein the set of available tasks comprises high frequency tasks.

15. A contextual help system, comprising:
a camera device connected to a computing device to capture a facial expression of a user;
a facial recognition analyzer to categorize the facial expression into a facial expression category;
a context analyzer to collect an application context from the computing device, wherein the application context comprises a recently performed task and a current application state, wherein the current application state comprises information on a current performance of an application in which the user is operating; and
a help interface to determine a set of available tasks relating to the application context and automatically execute one of the set of available tasks based on the facial expression category and the application context.

16. The system of claim 15, wherein the set of available tasks comprises creating a shortcut for the recently performed task.

17. The system of claim 15, wherein the camera device is further configured to capture a plurality of facial expressions, the context analyzer is further configured to collect a plurality of application contexts, and the help interface is further configured to execute one of the set of available tasks based on a combination of the plurality of facial expressions and the plurality of application contexts.

18. The system of claim 15, wherein the help interface is further configured to detect an error in the recently performed task, wherein automatically executing one of the set of available tasks comprises presenting a help display to a user.

19. The system of claim 15, wherein automatically executing one of the set of available tasks is further based on an input location of the recently performed task, wherein the set of available tasks comprises a task with an input location proximate the input location of the recently performed task.

20. The system of claim 15, wherein automatically executing one of the set of available tasks comprises determining a subsequent logical task, wherein the set of available tasks comprises high frequency tasks mapped to at least one facial expression category.
